(19) United States
(12) Patent Application Publication
(10) Pub. No.: US 2015/0250158 A1
(43) Pub. Date: Sep. 10, 2015

(54) WOODEN FISHING BOBBER

(71) Applicant: William M. Angevine, Panama City, FL (US)

(72) Inventor: William M. Angevine, Panama City, FL (US)

(21) Appl. No.: 14/166,820

(22) Filed: Mar. 6, 2014

(51) Int. Cl. A01K 93/00

(52) U.S. Cl. CPC A01K 93/00

(57) ABSTRACT

A wooden fishing bobber is a piece of wood no longer than 3 inches and not weighing more than 3 ounces which has a hole drilled through the wood. There is nothing attached directly to the wood.

The bobber is designed to be used when fishing fresh or salt water. The bobber is to be cast into the water and can remain floating or can be retrieved through the water creating splashes.

The bobber will have either line from the fishing pole (or reel) going directly through the hole or can have independent line with swivels on both ends which can be attached to the fishing pole or reel. There also can be beads on one or both ends just above the swivels in order to produce more noise for the fish to hear and to protect the knots tied to the swivels.

Drilling a hole through a piece of wood no longer than 4 inches and not weighing more than 4 ounces which will be utilized as a fishing bobber when fishing in either fresh or salt water.

The wood can act as a bobber or can be retrieved through the water depending on how the fisherman wants to work the bobber. There is nothing attached directly to piece of wood. The fishing line going through the hole can come directly from the fishing pole or can be independent having swivels on both ends which would tie to the line coming from the fishing pole. If it is independent, wire can be substituted for fishing line.

1. A Wooden Fishing Bobber is a piece of wood no longer than 3 inches and not weighing more than 3 ounces which has a hole drilled through the wood and is used for casting purposes when fishing. There is nothing attached directly to the wood.
